(19) United States
(12) Patent Application Publication
(10) Pub. No.: US 2025/0142508 A1
(43) Pub. Date: May 1, 2025

(54) METHOD AND APPARATUS FOR PROVIDING LOCALIZED SERVICE IN A WIRELESS COMMUNICATION SYSTEM

(71) Applicant: Samsung Electronics Co., Ltd., Suwon-si, Gyeonggi-do (KR)

(72) Inventors: Ashok Kumar NAYAK, Bangalore (IN); Varini GUPTA, Bangalore (IN)

(21) Appl. No.: 18/837,048

(22) PCT Filed: Mar. 29, 2023
(86) PCT No.: PCT/KR2023/004207

§ 371 Date: Aug. 8, 2024

(30) Foreign Application Priority Data
Mar. 29, 2022 (IN) 202241018279
Mar. 13, 2023 (IN) 2022 41018279

(51) Int. Cl. H04W 60/04; H04W 4/02; H04W 48/16

(52) U.S. Cl. CPC H04W 60/04; H04W 4/02; H04W 48/16

(57) ABSTRACT

The disclosure relates to a 5G or 6G communication system for supporting a higher data transmission rate. Specifically, the disclosure related to method performed by a user equipment (UE) in a wireless communication system. The method comprising includes receiving, from a base station of a hosting network, localized service support information. The method further includes performing, a manual selection of the hosting network based on the localized service support information. The method further includes transmitting, to the base station of the hosting network, a registration request message for a localized service from the hosting network. The method further includes receiving, from the base station of the hosting network, a registration accept message in response to the registration request message.

### TECHNICAL FIELD

The present disclosure relates generally to wireless communication system and, more specifically, the present disclosure relates to Non-Public Networks (NPNs) in a 3^{rd} Generation Partnership Project (3GPP). More particularly related to methods and systems for ensuring that the 3GPP is able to provide a mechanism/technique using which a User Equipment (UE) gets/obtains a localized service(s) from a hosting network when the UE does not have any prior subscription of the hosting network or a third party service provider/a network operator.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The principal object of the embodiments herein is to disclose methods and systems for ensuring that a 3GPP is able to provide a mechanism/technique using which a UE get localized services from a hosting network, when the UE does not have any prior subscription of the hosting network or a third party service provider/network operator.

Another object of the embodiments herein is to disclose that the UE does manual selection to see the networks (i.e., hosting networks or the like) which provides the localized service by reading broadcasted system information and then select that the network to get the localized service.

Another object of the embodiments herein is to disclose that the UE only use a network provided Data Network name (DNN) meant for the localized service and does not trigger a protocol data unit (PDU) session for any other DNN. The UE requests for the localized service in areas (list of tracking areas (TAs)) provided by the hosting network where the localized services are offered. In other words, the UE initiates the PDU session using the list of DNNs and/or the S-NSSAI for the localized service while the UE being present within the localized service area. Further, the UE starts to receive the localized service. Further, the UE determines that the UE is moving out of the localized service area and stops to initiate a request to obtain for the localized service based on the determination. Further, the UE performs the selection of another hosting network if the UE needs the localized service which is not available in the registered hosting network.

Another object of the embodiments herein is to disclose that the hosting network enforce the DNNs and localized service areas by rejecting the PDU session request if some UEs trigger for other DNNs nor meant for localized service or trigger with the DNN meant for localized service but not present within the localized service area.

### Solution to Problem

Accordingly, the embodiments herein provide methods for providing at least one localized service. The method includes receiving, by a User Equipment (UE), a broadcast support information associated with the at least one localized service from a hosting network. The UE does not have a subscription for accessing the at least one localized service. Further, the method includes performing, by the UE, a manual selection of the hosting network based on the received broadcast support information. Further, the method includes sending, by the UE, a localized service registration request message with an International Mobile Equipment Identity (IMEI) or a Permanent Equipment Identifier (PEI) to the hosting network to obtain the at least one localized service upon performing the manual selection of the hosting network. Further, the method includes receiving, by the UE, a localized service registration accept message from the hosting network. Further, the method includes sending, by the UE, a Protocol Data Unit (PDU) session to receive temporary subscription information from the hosting network. Further, the method includes deregistering, by the UE, the hosting network after successful provisioning of temporary subscription from the hosting network.

In an embodiment, the method includes receiving, by the UE, the temporary subscription for the UE based on the IMEI or the PEI associated with the UE. Further, the method includes registering, by the UE, successfully with the hosting network based on the temporary subscription to get the at least one localized service.

In an embodiment, the method includes receiving, by the UE, at least one of a localized service area, a list of Data Network Names (DNNs), and a Single-Network Slice Selection Assistance Information (S-NSSAI) for the at least one localized service after successful normal registration.

In an embodiment, the method includes initiating, by the UE, a PDU session using the at least one of the list of DNNs, and the S-NSSAI for the at least one localized service while the UE being present within the localized service area. Further, the method includes starting, by the UE, to receive the at least one localized service.

In an embodiment, the method includes determining, by the UE, that the UE is moving out of the localized service area. Further, the method includes stopping to initiate, by the UE, a request to obtain for the at least one localized service based on the determination.

In an embodiment, the method includes performing, by the UE, selection of another hosting network if the UE needs the at least one localized service which is not available in the registered hosting network.

Accordingly, the embodiments herein provide methods for providing at least one localized service. The method includes broadcasting, by a hosting network, at least one support information associated with at least one localized service. Further, the method includes receiving, by the hosting network, a localized service registration request message from a UE to obtain the at least one localized service upon the UE performs a manual selection of the hosting network. Further, the method includes accepting, by the hosting network, the localized service registration request message and a PDU session. Further, the method includes provisioning, by the hosting network, a temporary subscription to the UE. Further, the method includes receiving, by the hosting network, a normal registration to get the localized service to the UE.

In an embodiment, the method includes creating, by the hosting network, a temporary subscription for the UE based on an equipment identifier associated with the UE after identifying that UE does not have subscription with the hosting network. Further, the method includes accepting and sending, by the hosting network, a registration to provision the temporary subscription upon receiving the temporary subscription from the UE.

In an embodiment, the hosting network includes at least one of a provisioning server and a core network (CN) network function (NF) for creating the temporary subscription, wherein the hosting network is operated with at least one of a third party service provider and an application provider.

In an embodiment, the method includes receiving, by the hosting network, a protocol data unit (PDU) session from the UE to obtain a temporary subscription after successful localized registration. Further, the method includes deregistering, by the hosting network, the UE after successful provisioning of temporary subscription.

In an embodiment, the method includes providing at least one of a localized service area, a list of Data Network Names (DNNs), and a S-NSSAI for the at least one localized service to the UE after receiving the normal registration from the UE to get the at least one localized service. Further, the method includes determining a change in a localized service area, a new DNN for the at least one localized service and updating the change to the UE. Further, the method includes deregistering the UE (100) upon determining that a localized service validity condition has expired.

In an embodiment, the method includes receiving, by the hosting network, a PDU session request from the UE when the UE is not within a localized service area, or using other DNN or a S-NSSAI. Further, the method includes rejecting, by the hosting network, the PDU session request for the at least one localized service if the hosting network receives the PDU session request from the UE when the UE is not within the localized service area, or using other DNN or the S-NSSAI.

Accordingly, the embodiments herein provide a UE including a localized service controller coupled with a processor and a memory. The localized service controller is configured to receive a broadcast support information associated with the at least one localized service from a hosting network, where the UE does not have a subscription for accessing the at least one localized service. Further, the localized service controller is configured to perform a manual selection of the hosting network based on the received broadcast support information. Further, the localized service controller is configured to send a localized service registration request message with an IMEI or a PEI to the hosting network to obtain the at least one localized service upon performing the manual selection of the hosting network. Further, the localized service controller is configured to receive a localized service registration accept message from the hosting network. Further, the localized service controller is configured to send a PDU session to receive temporary subscription information from the hosting network. Further, the localized service controller is configured to deregister the hosting network after successful provisioning of temporary subscription from the hosting network.

Accordingly, the embodiments herein provide a hosting network including a localized service controller coupled with a processor and a memory. The localized service controller is configured to broadcast at least one support information associated with at least one localized service. Further, the localized service controller is configured to receive a localized service registration request message from a UE to obtain the at least one localized service upon the UE performs a manual selection of the hosting network. Further, the localized service controller is configured to accept the localized service registration request message and a PDU session. Further, the localized service controller is configured to provision a temporary subscription to the UE. Further, the localized service controller is configured to receive a normal registration to get the localized service to the UE.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

Aspects of the present disclosure provide efficient communication methods in a wireless communication system.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a schematic overview of a system for providing a localized service(s), according to the embodiments of the present disclosure;

FIG. 2 illustrates various hardware components of a UE, according to the embodiments of the present disclosure;

FIG. 3 illustrates various hardware components of a hosting network, according to the embodiments of the present disclosure;

FIG. 4 is a flow chart illustrating a method, implemented by the UE, for providing the localized service, according to the embodiments of the present disclosure;

FIG. 5 is a flow chart illustrating a method, implemented by the hosting network, for providing the localized service, according to the embodiments of the present disclosure;

FIG. 6 is a representation of a sequence of events when the UE tries to get the localized service through the hosting network when the UE does not have any prior subscription, according to embodiments of the present disclosure;

FIG. 7 illustrates a block diagram of a terminal (or a user equipment (UE), according to embodiments of the present disclosure; and

FIG. 8 illustrates a block diagram illustrating a structure of a network entity according to an embodiment of the present disclosure.

### MODE FOR THE INVENTION

Providing access to local services (or localized services) refers to the capability to provide access to a hosting network and a set of services offered by the hosting network provider, and 3rd party service providers including other network operators and 3rd party application providers. The services may be localized (i.e., provided in a specific/limited area) and may be bounded in time. A user of a User Equipment (UE) may become aware of an available access to the local services, and the process to gain and terminate access to the hosting network and local services. This process should be efficient, and convenient from a user experience standpoint.

Providing access to the local services creates new opportunities for the users and service providers. In an example, access can be provided in areas where there is no coverage provided by other networks (for example, on a cargo ship out at sea), or the access and local services can be established as needed (on a short-term basis), without the need for long term business relationships, permanently installed equipment, etc.

The type of local services and access for the localized services (e.g., watching a club cricket match, watching a club football match, watching a classical dance performance event or the like) via the hosting network can be promoted and arranged through different channels. Principally, the service operators (e.g., brick and mortar businesses, club mangers, construction contractors, first responder agencies, etc.) will provide information and proper incentive or instructions to the potential users so that they will seek to access the local services via the hosting networks.

A fifth generation (5G) network serves as a hosting network offering access to such localized services can be either a PNI-NPN or an Stand-alone Non-Public Network (SNPN). It is assumed that the hosting network and the localized services can be operated by different entities. The localized services may provide more than just data connectivity to end users, e.g., additional information/incentive/instructions in order to seek access to the localized services in.

3GPP Rel 18 service agreement 2 (SA2) architecture group is studying on how to provide localized services via the hosting network and some Key indicators (KIs) are defined. This particular use case/problem talks about the UE which does not have any prior subscription of the hosting network or of the third party service provider including the network operator.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The following abbreviations have been used in the patent disclosure:
a) AMF: Access and Mobility Management Function
b) UE: User Equipment
c) 3GPP: 3^{rd} Generation Partnership Project
d) NSSAI: Network Slice Selection Assistance Information
e) S-NSSAI: Single-Network Slice Selection Assistance Information
f) PDU: Session: Protocol Data Unit Session
g) SMF: Session Management Function
h) PCF: Policy Control Function
i) DNN: Data Network name
j) NPN: Non-Public Network

The embodiments herein achieve methods for providing at least one localized service. The method includes receiving, by a UE, a broadcast support information associated with the at least one localized service from a hosting network. The UE does not have a subscription for accessing the at least one localized service. Further, the method includes performing, by the UE, a manual selection of the hosting network based on the received broadcast support information. Further, the method includes sending, by the UE, a localized service registration request message with an IMEI or a PEI to the hosting network to obtain the at least one localized service upon performing the manual selection of the hosting network. Further, the method includes receiving, by the UE, a localized service registration accept message from the hosting network. Further, the method includes sending, by the UE, a PDU session to receive temporary subscription information from the hosting network. Further, the method includes deregistering, by the UE, the hosting network after successful provisioning of temporary subscription from the hosting network.

The proposed method ensures that a 3GPP is able to provide a mechanism or techniques using which a UE get localized services from a hosting network, when the UE does not have any prior subscription of a hosting network or a third party service provider/network operator. The proposed method can be used for increasing the user experience and enhancing the service to the user without using additional infrastructure and additional expensive.

In an embodiment, a human-readable network name per SNPN is only used for manual SNPN selection. If the SNPN supports the localized service, the humanreadable network name of the SNPN can be information related to the localized service. The mechanism for how human-readable network name is provided (i.e., whether it is broadcasted or unicasted) to the UE is specified in TS 38.331.

In the proposed method, the UE uses a network provided broadcast system information to see whether if the network supports the localized service and then using manual selection procedure select that particular network to get the localized service.

The UE which does not have any subscription information relies on the manual selection mode to select any network. If it does not get any information about a particular network of offering localized services then the UE can't select the network and hence won't get the localized service. Also as there can be many localized services which may be offered at different area's, hence the UE need to know the areas where its intended/requested localized services are available so that the UE can request accordingly. Otherwise, the requests will be rejected by the hosting network.

In an embodiment, the UE gets/obtains the localized services from the hosting network when the UE does not have prior subscription of the hosting network or of third party service provider including the network operator.

In an embodiment, the hosting network (e.g., RAN or the like) can broadcast support of localized services to the UE.

In an embodiment, the UE does manual selection of the hosting network and sends a localized service registration request message to get the service from the hosting network.

In an embodiment, the hosting network creates a temporary subscription for the UE per International Mobile Equipment Identity (IMEI)/Permanent Equipment Identifier (PEI) (for example) and accepts the registration to provision this temporary subscription through a restricted service. The hosting network can have PVS (provisioning server to have temporary subscription per IMEI/PEI). The hosting network will assign the CN NFs like Access and Mobility Management Function (AMF) entity, Session Management Function (SMF) entity, Policy Control Function (PCF) entity, and User Plane Function (UPF) entity for only to provide the temporary subscription provisioning to the UE.

In an embodiment, the UE initiates a PDU session to get temporary subscription from the hosting network and deregistered from the network after successful provisioning.

In an embodiment, the UE uses the temporary subscription and registers successfully with the hosting network.

In an embodiment, the hosting network provides the localized service area (list of TAs where thise localized service is available) and the list of DNNs for the localized service.

In an embodiment, the hosting network rejects the PDU session other than DNN assigned for the localized service.

In an embodiment, the UE shall not initiate any request if the UE moves out of the localized service area.

In an embodiment, the hosting network will update the UE, whenever a change in localized services occurs like addition of new services, or some service validity condition is over and corresponding DNNs. The network will deregister the UE once a localized service validity condition (like event is finished) has expired.

In an embodiment, the third party service provider/application provider can provision the list of UEs (IMEIs/PEIs or any other identifier) in the hosting network to provide the localized services.

In an embodiment, the UE can perform the manual selection again to select a different hosting network(s), if the preferred/required localized services are not provided from the attached hosting network.

In an embodiment, the hosting network will provide the list of DNNs applicable/configured for the localized services and the localized service area to the UEs, which have prior subscription of the hosting network or third party service provider including the network operator.

In an embodiment, the UE, which has prior subscription of the hosting network or third party service provider including the network operator, shall not initiate any PDU session for the DNNs related to the localized service if the UE moves out of the localized service area.

In an embodiment, the hosting network will update the UE whenever a change in localized services occurs like addition of new services, or some service validity condition is over and corresponding DNNs.

Referring now to the drawings, and more particularly to FIG. 1 through FIG. 8, where similar reference characters denote corresponding features consistently throughout the figures, there are shown at least one embodiment.

FIG. 1 illustrates a schematic overview of a system (300) for providing a localized service, according to the embodiments of the present disclosure. In an embodiment, the system (300) includes a UE (100) and a hosting network (200). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The hosting network (200) can be, for example, a radio access network (RAN). The hosting network (200) is used to provide the localized service at a specific cell or a specific location. In an embodiment, the hosting network (200) is same as a home network (not shown). In another embodiment, the hosting network (200) is different from the home network (not shown). The home network can be, for example, but not limited to a third generation (3G) network, a fourth generation (4G) network, a fifth generation (5G) network, or the like. When the hosting network (200) is different from the home network then the home network may have one service level agreement with hosting network (200) to give the localized service to its own subscriber. Similarly, some third party application service provider may provide localized service but may have service level agreement with the hosting network (200) to use the infrastructure of the hosting network (200) to provide the localized service. The localized service can be, for example, but not limited to a club cricket live streaming match, a club football live streaming match, a classical dance performance event, a public seminar event, a political event, or the like.

The hosting network (200) will broadcast for the support of the localized services. The UE (100) will do manual selection of the hosting network (200) to get the localized services. After selecting the hosting network (200), the UE (100) will send registration for the localized services. Since the UE (100) does not have a network assigned identifier at this point of time, the UE (100) will use identifiers like IMEI/PEI to connect to the hosting network (200). The hosting network (200) will accept the registration with a restricted service(s) to configure a temporary subscription for the UE (100). The restricted service means the network finds that the user does not have any subscription, so that the network only provides restricted service which is limited to only provisioning of temporary subscriptions. Other than that no regular or normal service like call or internet will be provided to the user. The UE (100) will initiate a PDU session to get temporary credentials of the hosting network (200). The hosting network (200) will assign temporary subscription per IMEI/PEI. After successful provisioning of temporary subscription, the UE (100) will be deregistered. The temporary subscription so created and provisioned in the UE (100) will contain a new identifier, so that the UE (100) can use the new identifier to re-connect to the hosting network (200). The UE (100) will perform a normal registration using temporary credentials of a hosting network service provider. The hosting network (200) will accept the registration and provide a localized service area. Also, the hosting network (200) will provide the list of DNNs for the localized services. The hosting network PCF will update the localized service DNN/Application & slices to access it in a UE Route Selection Policy (URSP) rule. The UE (100) starts getting the localized services using those DNNs & slices. The UE's mobility registration from different localized service area will be rejected. The hosting network (200) will update the UE (100) whenever a change in the localized services occurs like addition of new services, or some service validity condition is over and corresponding DNN. The hosting network (200) will deregister the UE (100) once a localized service validity condition (like event is finished) is expired.

FIG. 2 illustrates various hardware components of the UE (100), according to the embodiments of the present disclosure. In an embodiment, the UE (100) includes a processor (110), a communicator (120), a memory (130) and a localized service controller (140). The processor (110) is coupled with the communicator (120), the memory (130) and the localized service controller (140).

The localized service controller (140) receives the broadcast support information associated with the localized service from the hosting network (200), where the UE (100) does not have the subscription for accessing the at least one localized service. Based on the received broadcast support information, the localized service controller (140) performs the manual selection of the hosting network (200). Further, the localized service controller (140) sends the localized service registration request message with the IMEI or the PEI to the hosting network (200) to obtain the localized service upon performing the manual selection of the hosting network (200). Further, the localized service controller (140) receives a localized service registration accept message from the hosting network (200). Further, the localized service controller (140) sends the PDU session to receive temporary subscription information from the hosting network (200). Further, the localized service controller (140) deregisters the hosting network (200) after successful provisioning of temporary subscription from the hosting network (200).

In an embodiment, based on the IMEI or the PEI associated with the UE (100), the localized service controller (140) receives the temporary subscription for the UE (100). Further, the localized service controller (140) successfully registers with the hosting network (200) based on the temporary subscription to get the at least one localized service.

Further, the localized service controller (140) receives at least one of a localized service area, a list of DNNs, and the S-NSSAI for the at least one localized service after successful normal registration. Further, the localized service controller (140) initiates the PDU session using the at least one of the list of DNNs, and the S-NSSAI for the at least one localized service while the UE (100) being present within the localized service area. Further, the localized service controller (140) starts to receive the at least one localized service.

In an embodiment, further, the localized service controller (140) determines that the UE (100) is moving out of the localized service area. Further, the localized service controller (140) stops to initiate a request to obtain for the at least one localized service based on the determination. Further, the localized service controller (140) performs selection of another hosting network if the UE (100) needs the at least one localized service which is not available in the registered hosting network (200).

In general, the above operations are applicable for any UE which is having the subscription or credential to register with hosting network (200). Also, the normal UE which have subscription also can use the broadcast information to do the manual selection and then directly proceed for registration and PDU session to get localized (i.e., only skipping one round of localized registration & PDU session to get temporary subscription).

The localized service controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 illustrates various hardware components of the UE (100), but it is to be understood that other embodiments are not limited thereon. In other embodiments, the UE (100) may include less or more number of components. Further, the labels or names of the components are used only for illustrative purpose and does not limit the scope of the invention. One or more components can be combined to perform same or substantially similar function in the UE (100).

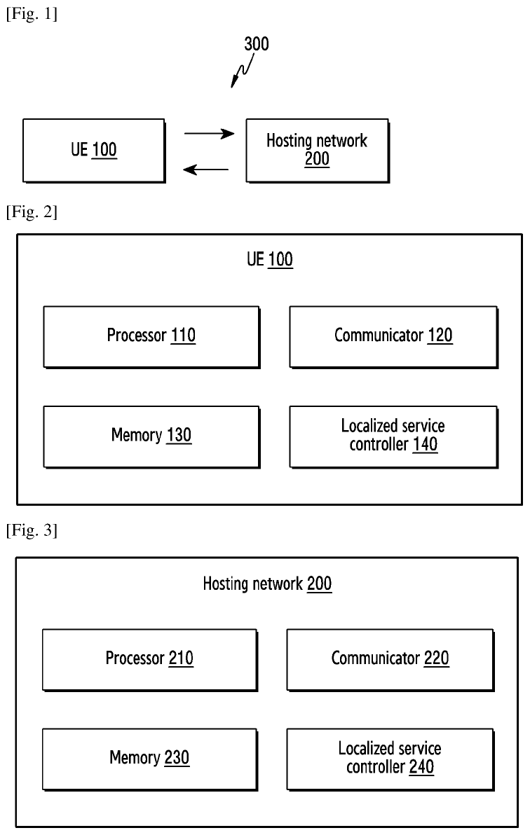

FIG. 3 illustrates various hardware components of the hosting network (200), according to the embodiments of the present disclosure. In an embodiment, the hosting network (200) includes a processor (210), a communicator (220), a memory (230) and a localized service controller (240). The processor (210) is coupled with the communicator (220), the memory (230) and the localized service controller (240).

In an embodiment, the hosting network (200) includes at least one of the provisioning server (not shown) and a CN NF entity (not shown) for creating the temporary subscription. The hosting network (200) is operated with the third party service provider and the application provider.

The localized service controller (240) broadcasts the support information associated with the localized service. Further, the localized service controller (240) receives the localized service registration request message from the UE (100) to obtain the localized service upon the UE (100) performs the manual selection of the hosting network (200). Further, the localized service controller (240) accepts the localized service registration request message and the PDU session. Further, the localized service controller (240) provisions the temporary subscription to the UE (100). Further, the localized service controller (240) receives the normal registration to get the localized service to the UE (100).

In an embodiment, the localized service controller (240) further creates the temporary subscription for the UE (100) based on an equipment identifier associated with the UE (100) after identifying that UE (100) does not have subscription with the hosting network. Further, the localized service controller (240) accepts and sends the registration to provision the temporary subscription upon receiving the temporary subscription from the UE (100).

In an embodiment, the localized service controller (240) further receives the PDU session from the UE (100) to obtain the temporary subscription after successful localized registration. Further, the localized service controller (240) deregisters the UE (100) after successful provisioning of temporary subscription.

In an embodiment, the localized service controller (240) further provides at least one of a localized service area, a list of Data Network Names (DNNs), and a S-NSSAI for the at least one localized service to the UE (100) after receiving the normal registration from the UE (100) to get the at least one localized service (100). Further, the localized service controller (240) determines a change in a localized service area, a new DNN for the at least one localized service and updating the change to the UE (100). Further, the localized service controller (240) deregisters the UE (100) upon determining that a localized service validity condition has expired.

In an embodiment, the localized service controller (240) further receives the PDU session request from the UE (100) when the UE (100) is not within a localized service area, or using other DNN or a S-NSSAI. Further, the localized service controller (240) rejects the PDU session request for the at least one localized service if the hosting network (200) receives the PDU session request from the UE (100) when the UE (100) is not within the localized service area, or using other DNN or the S-NSSAI.

The localized service controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 illustrates various hardware components of the hosting network (200), but it is to be understood that other embodiments are not limited thereon. In other embodiments, the hosting network (200) may include less or more number of components. Further, the labels or names of the components are used only for illustrative purpose and does not limit the scope of the invention. One or more components can be combined to perform same or substantially similar function in the hosting network (200).

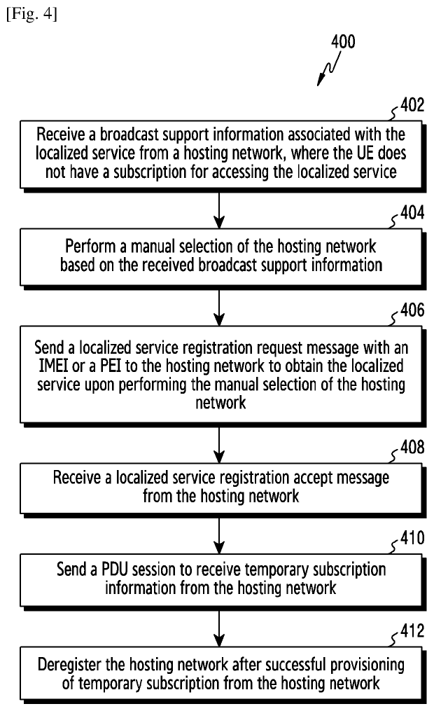

FIG. 4 is a flow chart (400) illustrating a method, implemented by the UE (100), for providing the localized service, according to the embodiments of the present disclosure. The operations (402 through 412) are handled by the localized service controller (140) of FIG. 2.

In step 402, the method includes receiving the broadcast support information associated with the at least one localized service from the hosting network (200). The UE (100) does not have the subscription for accessing the at least one localized service. In step 404, the method includes performing the manual selection of the hosting network (200) based on the received broadcast support information. In step 406, the method includes sending the localized service registration request message with the IMEI or the PEI to the hosting network (200) to obtain the at least one localized service upon performing the manual selection of the hosting network (200). In step 408, the method includes receiving the localized service registration accept message from the hosting network (200). In step 410, the method includes sending the PDU session to receive temporary subscription information from the hosting network (200). In step 412, the method includes deregistering the hosting network (200) after successful provisioning of temporary subscription from the hosting network (200).

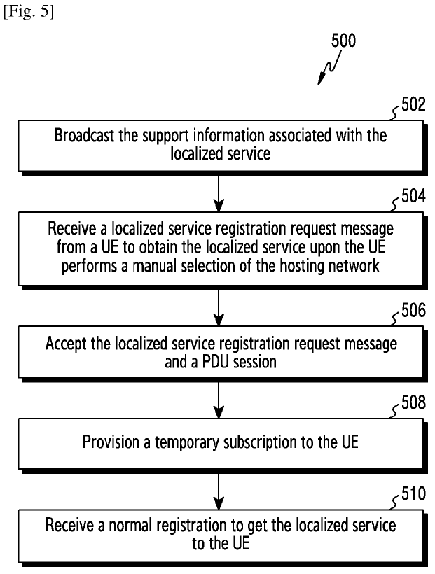

FIG. 5 is a flow chart (500) illustrating a method, implemented by the hosting network (200), for providing the localized service, according to the embodiments of the present disclosure. The operations (502 through 510) are handled by the localized service controller (240).

In step 502, the method includes broadcasting the support information associated with the at least one localized service. In step 504, the method includes receiving the localized service registration request message from the UE (100) to obtain the localized service upon the UE (100) performs the manual selection of the hosting network (200). In step 506, the method includes accepting the localized service registration request message and the PDU session. In step 508, the method includes provisioning the temporary subscription to the UE (100). In step 510, the method includes receiving the normal registration to get the localized service to the UE (100).

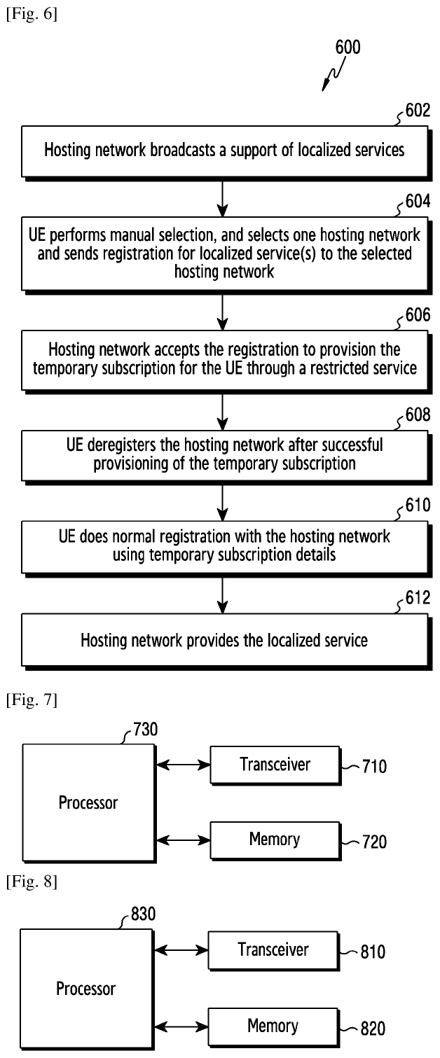

FIG. 6 is a representation of a sequence of events (600) when the UE (100) tries to get the localized service through the hosting network (200) when the UE (100) docs not have any prior subscription, according to embodiments of the present disclosure. The operations (602 through 612) are handled by the UE (100) and the hosting network (200).

In step 602, the hosting network (200) broadcasts the support of the localized services. At 604, the UE (100) performs manual selection, and selects one hosting network (200) and sends registration for the localized service(s). In step 606, the hosting network (200) accepts the registration to provision the temporary subscription for the UE (100) through the restricted service. In step 608, the UE (100) deregisters the hosting network (200) after successful provisioning of the temporary subscription. In step 610, the UE (100) does normal registration with the hosting network (200) using the temporary subscription details. In step 612, the hosting network (200) provides the localized service.

FIG. 7 illustrates a block diagram of a terminal (or a user equipment (UE)), according to embodiments of the present disclosure. FIG. 7 corresponds to the example of the UE (100) of FIG. 2.

As shown in FIG. 7, the UE according to an embodiment may include a transceiver 710, a memory 720, and a processor 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include a RF transmitter for upconverting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as read-only memory (ROM), random access memory (RAM), a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

FIG. 8 illustrates a block diagram showing an internal structure of a network entity, according to an embodiment of the present disclosure. Furthermore, the network entity corresponds to hosting network of FIG. 3.

As shown in FIG. 8, the network entity of the present disclosure may include a transceiver 810, a memory 820, and a processor 830. The transceiver 810, the memory 820, and the processor 830 of the network entity may operate according to a communication method of the network entity described above. However, the components of the terminal are not limited thereto. For example, the network entity may include more or fewer components than those described above. In addition, the processor 830, the transceiver 810, and the memory 820 may be implemented as a single chip. Also, the processor 830 may include at least one processor.

The transceiver 810 collectively refers to a network entity receiver and a network entity transmitter, and may transmit/receive a signal to/from a base station or a UE. The signal transmitted or received to or from the base station or the UE may include control information and data. In this regard, the transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the network entity. Also, the memory 820 may store control information or data included in a signal obtained by the network entity. The memory 820 may be a storage medium, such as ROM, RAM, a hard disk, a CD-ROM, and a DVD, or a combination of storage media.

The processor 830 may control a series of processes such that the network entity operates as described above. For example, the transceiver 810 may receive a data signal including a control signal, and the processor 830 may determine a result of receiving the data signal.

The proposed method can be used for increasing the user experience and enhancing the service to the user without using additional infrastructure and additional expensive.

The various actions, acts, blocks, steps, or the like in the flow charts (400-600) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method performed by a user equipment (UE) in a wireless communication system, the method comprising:
receiving, from a base station of a hosting network, localized service support information;
performing, a manual selection of the hosting network based on the localized service support information;
transmitting, to the base station of the hosting network, a registration request message for a localized service from the hosting network; and
receiving, from the base station of the hosting network, a registration accept message in response to the registration request message.

2. The method of claim 1,
wherein the localized service support information includes a network name for a user of the UE per SNPN for the manual selection of the hosting network.

3. The method of claim 1, further comprising:
receiving, from the base station of hosting network, a UE route selection policy (URSP) rule including information on an association between a UE application and a data network name (DNN) for the localized services, and information on an association between the UE application and a single-network slice selection assistance information (S-NSSAI) for the localized service.

4. The method of claim 3, further comprising:
initiating the PDU session using the information on the association between the UE application and the DNN, and information on the association between the UE application and the S-NSSAI for the localized service; and
receiving, from the base station of the hosting network, the localized service.

5. A method performed by a base station (BS) of a hosting network in a wireless communication system, the method comprising:
transmitting, to a user equipment (UE), localized service support information for a manual selection for the hosting network;
receiving, from the UE, a registration request message for a localized service from the hosting network; and
transmitting, to the UE, a registration accept message in response to the registration request message.

6. The method of claim 5,
wherein the localized service support information includes a network name for a user of the UE per SNPN for the manual selection of the hosting network.

7. The method of claim 5, further comprising:
transmitting, to the UE, a UE route selection policy (URSP) rule including information on an association between a UE application and a data network name (DNN) for the localized services, and information on an association between the UE application and a single-network slice selection assistance information (S-NSSAI) for the localized service.

8. The method of claim 7, further comprising:
transmitting, to the UE, the localized service,
wherein the PDU session using the information on the association between the UE application and the DNN, and information on the association between the UE application and the S-NSSAI for the localized service is initiated by the UE.

9. A User Equipment (UE) in a wireless communication system, the UE comprising:
a transceiver, and
a controller coupled with the transceiver and configured to:
receive, from a base station of a hosting network, localized service support information,
perform, a manual selection of the hosting network based on the localized service support information,
transmit, to the base station of the hosting network, a registration request message for a localized service from the hosting network, and receive, from the base station of the hosting network, a registration accept message in response to the registration request message.

10. The UE of claim 9,
wherein the localized service support information includes a network name for a user of the UE per SNPN for the manual selection of the hosting network.

11. The UE of claim 9, wherein the controller is further configured to:
receive, from the base station of hosting network, a UE route selection policy (URSP) rule including information on an association between a UE application and a data network name (DNN) for the localized services, and information on an association between the UE application and a single-network slice selection assistance information (S-NSSAI) for the localized service.

12. The UE of claim 9, wherein the controller is further configured to:
initiate the PDU session using the information on the association between the UE application and the DNN, and information on the association between the UE application and the S-NSSAI for the localized service, and
receive, from the base station of the hosting network, the localized service.

13. A base station (BS) of a hosting network in a wireless communication system, the BS comprising:
a transceiver, and
a controller coupled with the transceiver and configured to:
transmit, to a user equipment (UE), localized service support information for a manual selection for the hosting network,
receive, from the UE, a registration request message for a localized service from the hosting network, and
transmit, to the UE, a registration accept message in response to the registration request message.

14. The BS of claim 13,
wherein the localized service support information includes a network name for a user of the UE per SNPN for the manual selection of the hosting network.

15. The BS of claim 13, the controller is further configured to:
transmit, to the UE, a UE route selection policy (URSP) rule including information on an association between a UE application and a data network name (DNN) for the localized services, and information on an association between the UE application and a single-network slice selection assistance information (S-NSSAI) for the localized service, and
transmit, to the UE, the localized service,
wherein the PDU session using the information on the association between the UE application and the DNN, and information on the association between the UE application and the S-NSSAI for the localized service is initiated by the UE.
